(19) United States
(12) Patent Application Publication
(10) Pub. No.: US 2012/0037636 A1
(43) Pub. Date: Feb. 16, 2012

(54) Bag retainer

(76) Inventor: Glen Ratzlaff, West Kelowna (CA)

(21) Appl. No.: 13/137,404

(22) Filed: Aug. 11, 2011

Related U.S. Application Data
(60) Provisional application No. 61/344,521, filed on Aug. 13, 2010.

(51) Int. Cl. B65F 1/06; B65D 8/04

(52) U.S. Cl. 220/495.08; 220/661

(57) ABSTRACT

A port and method for retaining a sheet of material within a wall. The port comprises an opening extending through the wall and a single slot extending radially therefrom. The method comprises twisting a free edge of the material into a cylindrical shape, inserting the cylindrical shape of the material through the opening and pulling the cylinder into the slot so as to secure the cylindrical shape therein. A container may also have a sidewall and at least one a port for retaining a sheet of material within a wall of the container extending therethrough. Each port comprises an opening extending through the wall and a single slot extending radially therefrom. The slot may include a stress relieving bore having an inverted tear-drop shape at a distal end thereof.

### CROSS REFERENCE TO RELATED APPLICATION

This application claims priority from U.S. Provisional Patent Application No. 61/344,521 filed Aug. 13, 2010 entitled Waste Container Support.

### BACKGROUND OF THE INVENTION

1. Field of Invention The present invention relates to waste disposal in general and in particular to a method and apparatus for securing and supporting a disposable waste bag.

2. Description of Related Art

Disposable and reusable plastic bags are commonly used for collecting household garbage and other refuse. It is frequently desirable to maintain such a bag upright with an opening disposed in an upward direction. Current methods for maintaining such bags upright has been to provide a garbage can in which to place the bag or an external frame to support the bag. However difficulties exist with such current bag supports.

Conventional methods for supporting disposable bags may be to place the bag within a garbage can or other external frame. The use of large disposable plastic trash bags for the purpose of disposing of garden, yard or light industrial waste presents a number of problems. Such bags may commonly be damaged during the process of filling the bag or removing it from the support structure by rough or sharp objects placed within the bag. In particular, yard waste placed into a bag supported by a wire frame may easily puncture the bag.

Current methods of securing bags within such garbage cans or frames has been unsatisfactory. Many garbage cans and wire support stands do not have dedicated fasteners for securing the garbage bag thereto. One conventional method of securing a garbage bag within a garbage can is to stretch the bag over the mouth of the garbage can. In such uses, the garbage bag is retained on the garbage can by relatively weak forces such as the tension of the plastic bag wall and friction between the plastic bag and the container. Such lack of a gripping means to secure the bag to the garbage can may lead to slipping of the bag within the garbage can as the trash bag is loaded with waste or compacted.

Previous designs aimed at securing disposable plastic trash bags in place to trash canisters have also been unsatisfactory. Some of such methods have included hooks or sharp elements designed to snag or perforate the margin of trash bags. Perforating or otherwise snagging the sheet of the bag results in holes proximate to the edge of the bags that may compromise the strength & integrity of the bags. Other bag holding attempts have included devices such as spring loaded clips or elastic bands to frictionally secure the bag to the surface of the garbage can or the like. Such additional and frequently moving or loose parts used in such methods may be susceptible to damage or loss thereby limiting their long-term usefulness.

Previous attempts to support disposable refuse bags for yard waste have also unacceptably obstructed the installation and removal of the bag from the structure. In particular, when a yard waste bag is located within a conventional outdoor trash canister, air may be trapped between the wall of the trash bag and the wall of the canister. This trapped air may impede the filling of the bag with waste. Furthermore, if all air is successfully removed between the plastic trash bag and the wall of the trash canister, the fully loaded plastic trash bag can be very difficult to dislodge from a standard outdoor trash canister due to a vacuum that may develop between the trash bag wall and trash canister wall. Similarly, when supported by metal wire support stands, a plastic waste bag filled to full capacity may become trapped between the metal uprights and the top frame making removal of the fully loaded bag from the support stand difficult.

### SUMMARY OF THE INVENTION

According to a first embodiment of the present invention there is disclosed a port for retaining a sheet of material within a wall. The port comprises an opening extending through the wall and a single slot extending radially therefrom.

The wall may comprise a side wall of an upright container. The opening may be substantially oval shaped.

The slot may include a stress relieving bore at a distal end thereof. The stress relieving bore may have a tear-drop shape. The tear-drop shape may be inverted so as to have a rounded portion disposed distally from the opening. The slot may extend perpendicularly to a long axis of the oval shaped opening. The slot may have a radiused junction with the oval. The slot may be formed between parallel opposed sides in the sidewall.

According to a further embodiment of the present invention there is disclosed a container having a sidewall and at least one port for retaining a sheet of material within a wall of the container extending therethrough. Each port comprises an opening extending through the wall and a single slot extending radially therefrom.

The opening of the at least one port may include a long axis extending substantially perpendicularly to a top edge of the sidewall. The slot may extend towards a top edge of the sidewall.

According to a further embodiment of the present invention there is disclosed a method for retaining a sheet of material within a wall. The method comprises twisting a free edge of the material into a cylindrical shape, inserting the cylindrical shape of the material through an opening of a port in the wall, said port having the opening extending through the wall and a single slot extending radially therefrom and pulling the cylinder into the slot so as to secure the cylindrical shape therein.

According to a further embodiment of the present invention there is disclosed a method for supporting a disposable refuse bag. The method comprises providing a substantially vertical continuous wall having a top edge, substantially aligning the sheet of the refuse bag with a first surface of wall and passing a free edge of the bag over the top edge of the wall. The method further comprises substantially aligning a portion of the sheet of the bag with a second opposed surface of the wall, twisting a free edge of the material into a cylindrical shape, inserting the cylindrical shape of the material through an opening of a port in the wall, said port having the opening extending through the wall and a single slot extending radially therefrom and pulling the cylinder into the slot so as to secure the cylindrical shape therein.

The bag may be suspended inside a cavity defined by the wall. The bag may be suspended to an exterior of the wall.

According to a further embodiment of the present invention there is disclosed an apparatus for supporting a disposable refuse bag comprising a substantially vertical continuous wall extending between top and bottom edges, the top edge defining a top opening and at least one port extending through the wall, the port comprising an opening extending through the wall and a single slot extending radially therefrom.

The opening may be substantially oval shaped. A long direction of the oval may extend parallel to the top edge of the wall. The opening may be located proximate to the top edge of the wall. The slot may extend towards the top edge of the wall.

The slot may include a strain relieving bore at a distal end thereof. The strain relieving bore may have a tear-drop shape. The tear-drop shape may be inverted such that a rounded portion thereof is disposed towards the top edge. The slot may extend perpendicular to a long axis of the oval. The slot may have a radiused connection with the oval.

The bottom edge may define a bottom opening. The bottom edge may include expansion slots extending perpendicularly therein. The expansion slots may have stress relieving bores at the distal ends thereof.

The apparatus may include a bottom panel extending theracross defining a bottom of a cavity defined by the apparatus. The wall may include integrated carrying handles therein. The apparatus may further include a lid sized to cover the top opening.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention wherein similar characters of reference denote corresponding parts in each view,

FIG. 1 is a perspective view of a waste bag insert according to a first embodiment of the present invention.

FIG. 2 is a detailed view of the port for securing a waste bag of the waste bag insert of FIG. 1.

FIG. 3 is a perspective view of a waste bag being applied to the interior of a garbage can according to a further embodiment of the present invention.

FIG. 4 is a perspective view of an edge of the waste bag of FIG. 3 being twisted for application into the port of the garbage can.

FIG. 5 is a perspective view of the waste bag insert of FIG. 1 being applied to the interior of a yard waste bag.

FIG. 6 is a cross sectional view of the slot of the port taken along the line 6-6 of FIG. 2.

### DETAILED DESCRIPTION

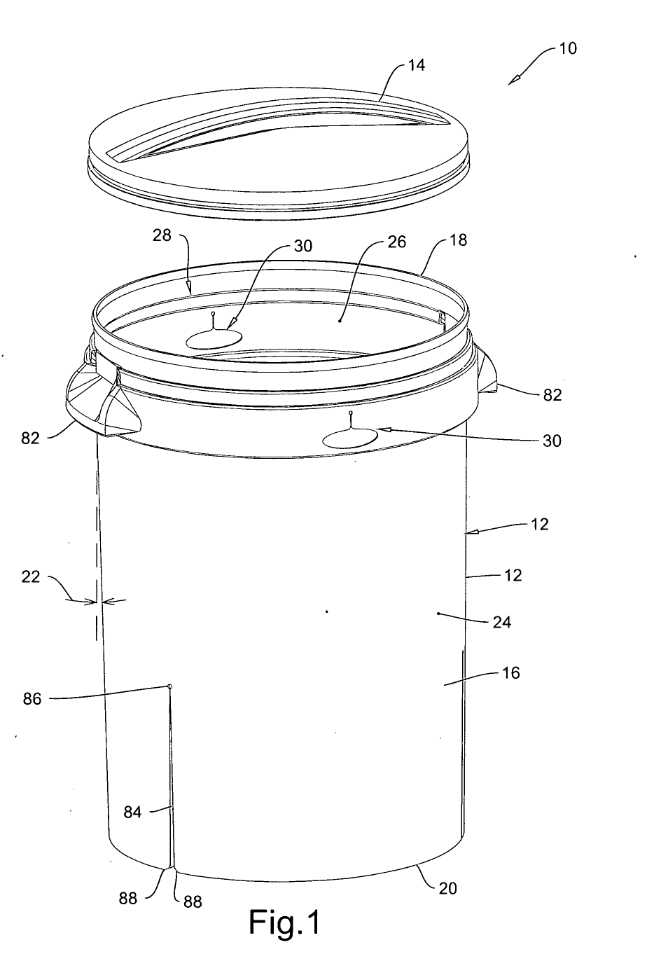

Referring to FIG. 1, an apparatus for supporting a yard waste bag according to a first embodiment of the invention is shown generally at 10. The apparatus 10 comprises a support body 12 and a lid 14 adapted to snugly fit the top opening of the support body 12 as is commonly known in the art. The support body 12 comprises an upright continuous wall 16 having top and bottom edges, 18 and 20, respectively. The top edge 18 defines a top opening while the bottom edge 20 may define a bottom opening or have a closed bottom as will be described more fully below. The support body is formed of a wall of material having outer and inner surfaces, 24 and 26, respectively. The inner surface 26 defines a central cavity 28. The wall 16 may optionally have a taper between the top and bottom edges 18 and 20 generally indicated at 22. The taper may have an angle between 2.5 and 4.0 degrees as are commonly known in waste receptacles. The support body 12 may be sized to be received within a yard waste bag as will be further described below.

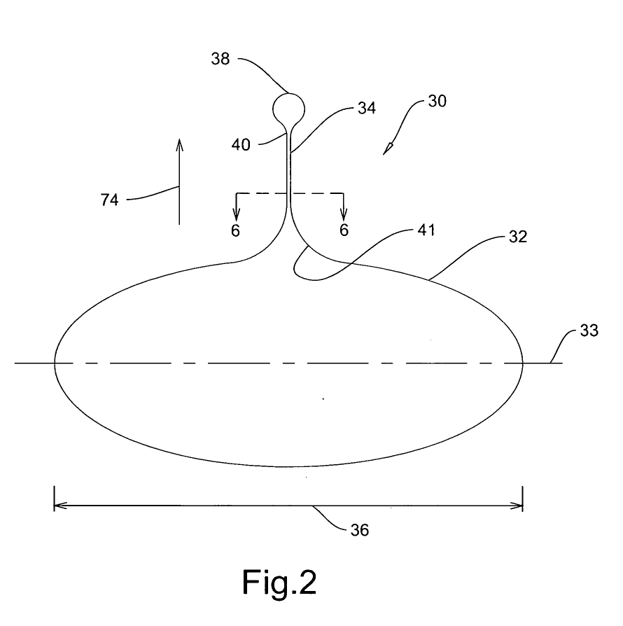

The wall 16 includes at least one retaining port 30 located proximate to the top edge 18 as illustrated in detail in FIG. 2. The ports 30 include an opening 32 and a slot 34 extending therefrom. The opening 32 of the port 30 may have a substantially oval outline as illustrated. It will be appreciated, however that other shapes may also be useful as well, such as, by way of non-limiting example, square, rectangular, circular, ellipse, polygonal or irregular. The opening 32 is sized to loosely receive at least one finger therein. In some embodiments, the opening 32 may be sized to receive two or more fingers of a user. The oval outline of the opening 32 may have a long direction generally indicated at 36 along an axis 33 wherein the slot 34 extends from the opening 32 in a direction substantially perpendicular to the long direction 36. In practice, it has been found that a long distance 36 of the opening of approximately 3 inches (77 mm) has been adequate although it will be appreciated that other lengths may be useful as well.

The slot 34 may include a stress relief 38 at a distal end 40 thereof. It will be appreciated that the stress relief may comprise a substantially circular bore, although it will be appreciated that other shapes will be useful as well so as to increase the radius at the distal end of the slot so as to reduce the stress thereon and therefore to prevent propagation of the slot into the wall 16.

Optionally, the stress relief 38 may have an inverted teardrop shape as illustrated in FIG. 2. The stress relief 38 may have a diameter of between 1/16 or more (1.6 mm) with a diameter of 5/64 of an inch (2 mm) being found to be particularly useful although it will be appreciated that other diameters may be useful as well depending upon the material utilized to form the support body 12 and the waste bag 8 to be supported. It will be appreciated that the radiused entrance to the stress relief of a teardrop shape as illustrated allows the easy release of the waste bag without snagging or tearing of the bag material at the junction of slot and the stress relief. Conversely, a simple round stress relief has distinct corners where the slot intersects the stress relief. Such corners may be prone to snag or tear the waste bag. The slot 34 may also have rounded entrances thereto from the opening 32 generally indicated at 41. The slot 34 has a gap distance sufficient to permit a portion of a twisted garbage bag to be securely retained therebetween. The slot 34 may have a length of between ½ and 2 inches (13 and 51 mm) although other lengths may be useful as well. In particular it has been found that a length of between ¾ and 1 and ¼ of an inch (19 and 32 mm) has been particularly useful for retaining a waste bag therein.

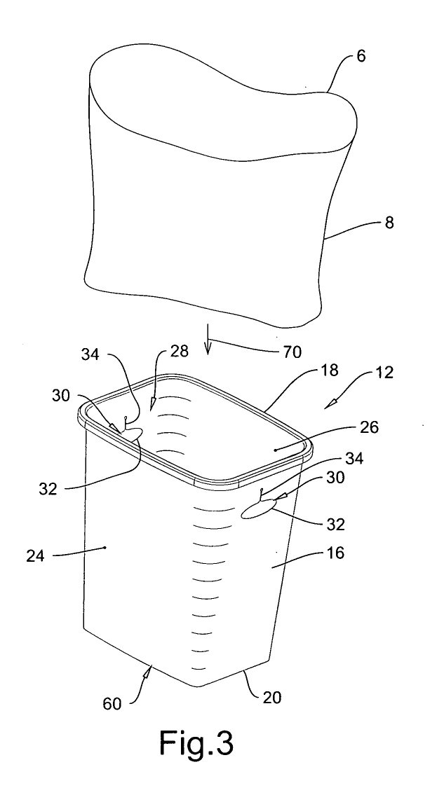

As illustrated in FIGS. 1 and 3, the ports 30 may be positioned adjacent to the top edge 18 of the apparatus 10 although it will also be appreciated that the ports 30 may be positioned at other locations on the apparatus as well. The ports 30 are positioned with the slot 34 extending in a direction generally towards the top edge 18 from the opening 32.

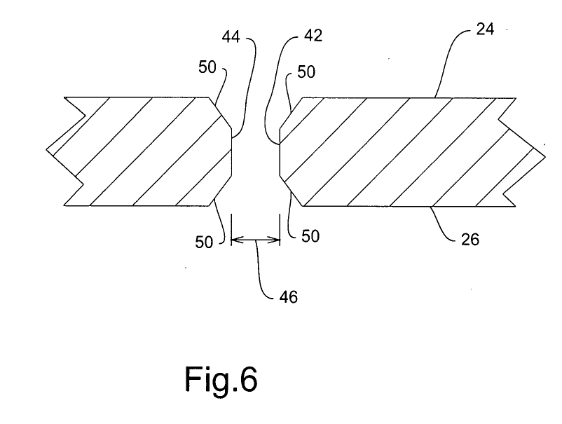

Turning now to FIG. 6, the slot may be formed of opposing first and second slot edges, 42 and 44, respectively having a minimum distance indicated generally at 46 therebetween. In practice, it has been found that a minimum distance of between 1/96 and 1/48 of an inch (0.3 and 0.5 mm) has been useful for use with yard waste garbage bags although it will be appreciated that other dimensions may also be useful as well for waste bags of different thicknesses. The first and second slot edges 42 and 44 may be substantially parallel to each other and have bevelled entrances and exits 50 to the slot. The bevelled entrances and exits 50 permit the opposing slot edges 42 and 44 to move independently of each other when a twisted bag material is pulled therebetween as further described below. Although bevelled entrances and exits are described herein, it will be appreciated that rounded corners may also be utilized so as to reduce sharp edges within the slot that may damage the garbage bag.

Turning now to FIG. 3, the apparatus 10 may have a closed bottom 60 located at the bottom edge 20 of the support body 12. With such a bottom 60, the apparatus forms a garbage can or other similar container. Optionally the apparatus 10 may omit the closed bottom 60 such that the bottom edge 18 forms a bottom opening as illustrated in FIG. 1 so as to form a sleeve. As illustrated, the support body 12 may be formed into a plurality of substantially planar walls so as to define a rectangular cavity 28 therein. Alternatively, the support body 12 may be formed into a continuous curved wall so as to form a cylindrical cavity 28 therein as illustrated in FIG. 1. It will be appreciated that other shapes of the cavity 28 may also be formed by different orientations and arrangements of the support body 12. As illustrated, the apparatus 10 may include two ports 30 located at opposed locations on the support body 12 which may, by non-limiting example, be along the short walls of a rectangular shaped garbage can. It will be appreciated that other numbers and arrangements of the ports 30 may also be utilized.

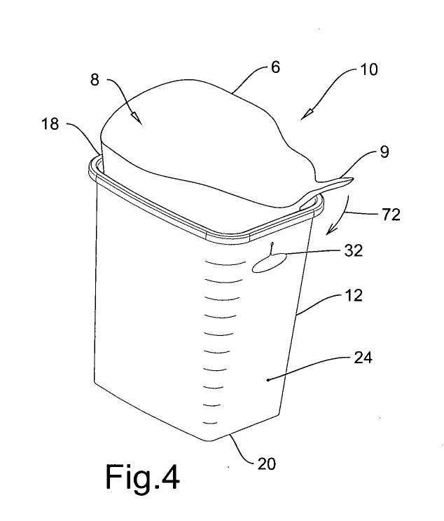

In operation, a garbage or other similar disposable waste bag 8 is inserted into the cavity 28 in a direction generally indicated at 70. The waste bag includes a top edge 6 wherein the waste bag 8 may be inserted such that the top edge 6 of the waste bag 8 corresponds to the top edge 18 of the apparatus. A user may then twist a portion of the edge 6 of the waste bag 8 into a substantially cylindrical portion 9 as illustrated in FIG. 4. The user may then insert the cylindrical portion 9 into the opening 32 of the port through from the outer surface 24 of the support body 12 in a direction generally indicated at 72 in FIG. 4. The user may then pull the cylindrical portion 9 in a generally upward direction, generally indicated at 74 in FIG. 2 so as to lodge the cylindrical portion therein and thereby to secure the waste bag 8 by the port 30. A similar process may then be repeated for the other ports 30 in the apparatus so as to suspend the waste bag therefrom. The remainder of the edge 6 of the waste bag 8 may then be draped over the top edge 18 of the apparatus 10. Such an embodiment may be useful for a kitchen or other type of garbage can. The waste bag 8 may be removed from the support body 12 by a reverse operation comprising pulling the cylindrical portion downwardly out of the slot 34, removing the cylindrical portion 9 from the port 30 and the lifting upwardly on the waste bag to remove it from the cavity 28 of the apparatus.

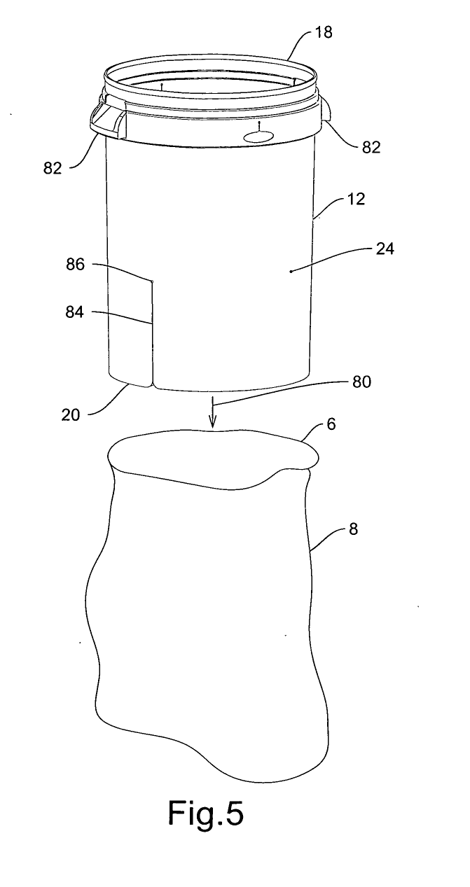

With reference now to FIG. 5, an alternative embodiment is illustrated wherein the apparatus 10 comprises an open bottom sleeve. In such an embodiment, the apparatus does not have a bottom across the bottom edge 20 of the wall 16. The apparatus 10 in such an embodiment may be sized to be inserted into the interior of a waste bag 8 such as a yard waste bag. Accordingly, the outer surface 24 of the wall 16 will bear against the inside of the waste bag 8. The edge 6 of the waste bag 8 may then be draped over the top edge 18 of the apparatus and twisted and secured within the ports 30 as described above from the inside or cavity 28 of the apparatus. Such an embodiment may be useful with waste bags which are intended to hold a large amount of debris that may be sharp or pointed such as, for example a yard waste bag. In such embodiments, the support body 12 will protect the bag from being punctured, ripped or otherwise damaged by the insertion of the waste therein. Additionally, the support body 12 supports the waste bag 8 in an open and upright position to facilitate loading and compaction by the user.

The support body 12 may optionally include handles 82 or other suitable lifting means located on the outer surface 24 thereof as are known in the art. The handles 82 will assist in moving the apparatus 10 and waste bag 8 about as well as with removing the support body from the waste bag 8. As illustrated in FIGS. 1 and 5, the support body 12 may also include slots 84 extending from the bottom edge 20. The slots 84 permit the bottom portion of the support body to be radially expandable so as to facilitate loading of the waste bag 8 with debris as well as facilitating the removal of the support body 12 therefrom. It will be appreciated that the slots 84 prevent the slightly conical support body 12 from being jammed with debris compacted into the waste bag 8. The support body 12 may include at least one slot 84. As illustrated, in some embodiments, the support body 12 may include 3 or more slots. Each slot 84 includes a stress relief 86 at a distal end thereof and may optionally include rounded corners 88 at an intersection with the bottom edge 20 of the wall 16 so as to prevent snagging on the waste bag 8 as the support body 12 is inserted into the waste bag. The stress relief 86 may have a diameter of between 1/16 or more (1.6 mm) with a diameter of ¼ of an inch (6 mm) being found to be particularly useful although it will be appreciate that other diameters may be useful as well. The slots 84 may extend up to ⅓ of the height of the wall and may optionally include rounded corners generally indicated at 88 with the bottom edge 20 of the wall 16. It will be appreciated that the taper 22 permits easier insertion of the support body 12 into a waste bag 8 as further described below. In addition, the taper 22 ensures adequate room inside the waste bag 8 for settling of the compacted waste therein when the support body 12 is removed from the waste bag so as to facilitate subsequent closure of the waste bag 8. It will also be appreciated that the taper 22 assists in separating the support body 12 from the waste bag 8 so as to prevent friction and/or a vacuum therebetween from resisting removal of the support body 12 from the waste bag 8.

Securing a rolled or twisted portion of the waste bag 8 distributes the tension created in the bag over a greater surface of the bag. Furthermore, securing the waste bag 8 from a location on the exterior of a garbage can assists in transferring some of the support for the contents of the bag to the top edge 18 of the garbage can thereby further reducing the tension on the location of the bag actually gripped by the port. It will be appreciated that these measures taken together serve to more evenly distribute the load bearing tension in the bag thereby increasing the amount of weight the bag may carry. It will be appreciated that retaining a waste bag 8 within a fastening structure in the support body without puncturing, tearing or otherwise damaging the sheet material of the bag maintains the strength of the bag by not unduely damaging it.

The apparatus 10 may be formed of any suitable material such as by way of non-limiting example, metal such as steel, galvanized steel or aluminium, plastic such as polyethylene, Polypropylene, Polyvinyl chloride and Polystyrene. The material for the apparatus 10 should be selected to be reasonably lightweight while providing sufficient strength and rigidity to support the waste bag in an upright and open position. The material should also be durable and resistant to impacts and abrasion.

While specific embodiments of the invention have been described and illustrated, such embodiments should be considered illustrative of the invention only and not as limiting the invention as construed in accordance with the accompanying claims.

What is claimed is:

1. A port for retaining a sheet of material within a wall, the port comprising an opening extending through said wall and a single slot extending radially therefrom.

2. The port of claim 1 wherein wall comprises a side wall of an upright container.

3. The port of claim 1 wherein said opening is substantially oval shaped.

4. The port of claim 3 wherein said slot includes a stress relieving bore at a distal end thereof.

5. The port of claim 4 wherein said stress relieving bore has a tear-drop shape.

6. The port of claim 5 wherein said tear-drop shape is inverted so as to have a rounded portion disposed distally from said opening.

7. The port of claim 6 wherein said slot extends perpendicularly to a long axis of said oval shaped opening.

8. The port of claim 7 wherein said slot has a radiused junction with said oval.

9. The port to claim 7 wherein said slot is formed between parallel opposed sides in said sidewall.

10. The port to claim 9 wherein said parallel opposed sides have bevelled entrances and exits.

11. A container having a sidewall and at least one of the ports of claim 1 extending therethrough.

12. The container of claim 11 wherein said opening is substantially oval shaped.

13. The container of claim 12 wherein said opening of at least one port includes a long axis extending substantially perpendicularly to a top edge of said sidewall.

14. The container of claim 13 wherein said slot extends towards a top edge of said sidewall.

15. A method for retaining a sheet of material within a wall, the method comprising:
twisting a free edge of the material into a cylindrical shape;
inserting said cylindrical shape of said material through an opening of a port in said wall, said port having said opening extending through said wall and a single slot extending radially therefrom; and
pulling said cylinder into said slot so as to secure said cylindrical shape therein.
